(19) United States
(12) Patent Application Publication
(10) Pub. No.: US 2011/0069761 A1
(43) Pub. Date: Mar. 24, 2011

(54) PARALLEL ENCODING DEVICE, RECORDING MEDIUM, AND IMAGING DATA ENCODING METHOD

(75) Inventor: HIROAKI SUGITA, Kawasaki-shi (JP)

(73) Assignee: KABUSHIKI KAISHA TOSHIBA, Tokyo (JP)

(21) Appl. No.: 12/881,357

(22) Filed: Sep. 14, 2010

(30) Foreign Application Priority Data
Sep. 18, 2009 (JP) 2009-217888

(51) Int. Cl. H04N 11/02

(52) U.S. Cl. 375/240.16; 375/E07.124

(57) ABSTRACT

According to one embodiment, a device includes a storage unit, a processing unit, a detection unit, a control unit. The storage unit stores control information indicating progress states of process modes for encoding with respect to process blocks. The processing unit parallelly executes executable process modes for executable process blocks, based on the control information and a dependency relationship between the process modes for the process blocks. The detection unit detects error occurring in processing of the processing unit. The control unit updates to a re-executable state, if the error occurring is detected, the progress state of an error process block and the progress state of a process block dependent on the error process block in the control information.

### CROSS-REFERENCE TO RELATED APPLICATIONS

This application is based upon and claims the benefit of priority from Japanese Patent Application No. 2009-217888, filed Sep. 18, 2009; the entire contents of which are incorporated herein by reference.

### FIELD

Embodiments described herein relate generally to an encoding device for encoding image data, a recording medium, and a method of encoding image data.

### BACKGROUND

An encoding technique complying with the H.264 standard executes motion vector search processing, mode determination processing, entropy encoding processing, and the like.

In the conventional encoding technique including the motion vector processing, mode determination processing and entropy encoding processing, the mode determination processing and entropy encoding processing operate not parallelly but serially. Thus, even if an error occurs in the entropy encoding processing, it is possible to readily restart the processing from the mode determination processing.

In the prior art technique, the processes are not parallelly executed among a plurality of frames. Therefore, even though the mode determination processing is performed again, the motion vector search processing need not be executed again.

In contrast to this, assume that the processes such as the motion vector search processing and the mode determination processing are parallelly executed in the conventional encoding technique. If an error occurs in the entropy encoding processing, it is necessary to re-execute the mode determination processing. Furthermore, since the result of the mode determination processing changes, it is also necessary to re-execute the motion vector search processing, which refers to the result of the mode determination processing.

As described above, in the prior art encoding technique, there is an increase in the number of processes which need to be re-executed if the error occurs when parallelly executing processes. It is, therefore, difficult to implement error processing in parallel encoding.

### BRIEF DESCRIPTION OF THE DRAWINGS

FIG. 1 is a block diagram showing an example of an encoding device according to a first embodiment;

FIG. 2 is a block diagram showing an example of a hardware arrangement of the encoding device according to the first embodiment;

FIG. 3 is a view showing an example of a dependency relationship between process modes for process blocks;

FIG. 4 is a view showing an example of a progress state of parallel encoding;

FIG. 5 is a view showing an example of control information according to the first embodiment; and

FIG. 6 is a flowchart illustrating an example of processing of the encoding device according to the first embodiment.

### DETAILED DESCRIPTION

In general, according to one embodiment, a parallel encoding device includes a storage unit, a parallel processing unit, a detection unit, and a control unit. The storage unit stores control information indicating progress states of process modes for encoding with respect to process blocks. The process blocks are obtained by dividing image data. The parallel processing unit parallelly executes executable process modes for process blocks in an executable state based on the control information stored in the storage unit and a predetermined dependency relationship between the process modes for the process blocks. The detection unit detects error occurring in processing performed by the parallel processing unit. If the detection unit detects the error occurring, the control unit updates, to a re-execution state, a progress state of an error process block and a progress state of a process block dependent on the error process block in the control information stored in the storage unit.

Embodiments will be explained below with reference to accompanying drawings. In the drawings, the same reference numbers and symbols denote the same or substantially same elements, and a description thereof will be omitted or briefly described. Only different parts will be explained in detail.

### First Embodiment

In the first embodiment, there will be given a description of a parallel encoding device which parallelly encodes moving image data complying with the H.264 standard, and efficiently re-executes encoding if an error occurs in the encoding.

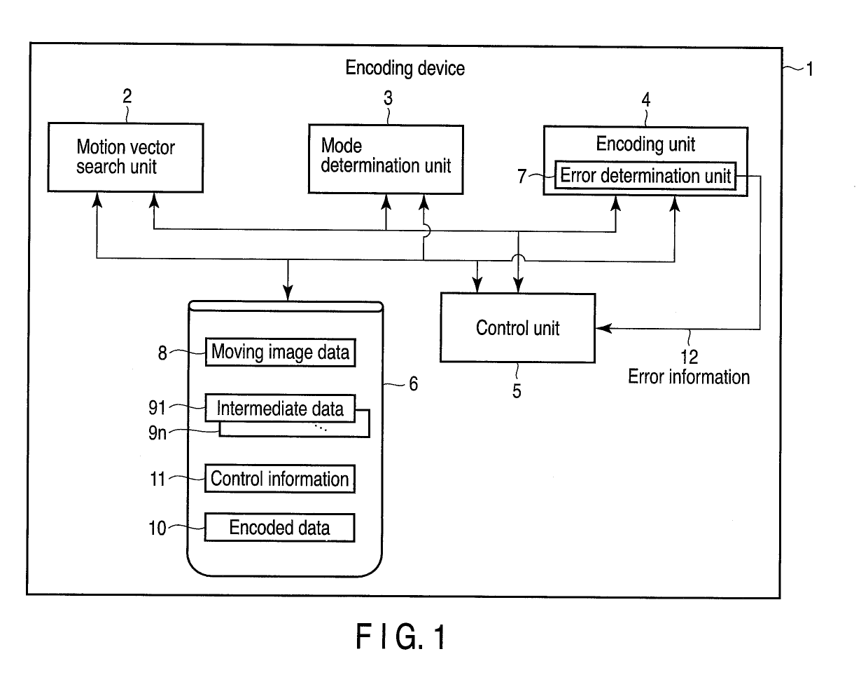

FIG. 1 is a block diagram showing an example of an encoding device according to this embodiment.

An encoding device 1 according to the embodiment includes a motion vector search unit 2, a mode determination unit 3, an encoding unit 4, a control unit 5, and a storage device 6.

In this embodiment, the control unit 5 is arranged separately from the motion vector search unit 2, the mode determination unit 3, and the encoding unit 4. The function of the control unit 5, however, may be divided and incorporated in the motion vector search unit 2, the mode determination unit 3, and the encoding unit 4.

The encoding unit 4 includes an error determination unit 7. Note that the encoding unit 4 and the error determination unit 7 may be arranged separately from each other.

The storage device 6 stores moving image data 8 to be encoded, various intermediate data 91 to 9n to be generated during encoding, encoded data 10, and control information 11 indicating progress states of process modes ME, IC, EC, and GR for encoding with respect to process blocks which are obtained by dividing the moving image data 8. In this embodiment, each process block includes a macroblock or sequence macroblocks.

A main memory is used for the storage device 6. The storage device 6 may be divided into storage devices.

The motion vector search unit 2, the mode determination unit 3, and the encoding unit 4 respectively execute the motion vector search processing, mode determination processing and encoding processing (e.g., entropy encoding processing) on the moving image data 8 stored in the storage device 6, and stores the generated encoded data 10 in the storage device 6. During the motion vector search processing, mode determination processing, and encoding processing, the intermediate data 91 to 9n are stored in and read out from the storage device 6.

Based on the control information 11 and a dependency relationship between the process modes and the process blocks relating to the motion vector search processing, the motion vector search unit 2 searches for a process block on which the motion vector search processing is executable, and then executes the motion vector search processing on the found process block.

Based on the control information 11 and a dependency relationship between the process modes and the process blocks relating to the mode determination processing, the mode determination unit 3 searches for a process block on which the mode determination processing is executable, and then executes the mode determination processing on the found process block.

Based on the control information 11 and a dependency relationship between the process modes and the process blocks relating to the encoding processing, the encoding unit 4 searches for a process block on which the encoding processing is executable, and then executes the encoding processing on the found process block.

If an error occurs in the encoding processing, or an error occurs in the encoded data 10, the error determination unit 7 of the encoding unit 4 notifies the control unit 5 of error information 12.

The error information 12 contains, e.g., the identification information of a frame or process block where the error has occurred, and information indicating an error type.

Upon reception of the error information 12, the control unit 5 updates the control information 11 so as to re-execute the encoding on the frame or process block where the error has occurred. Based on the above various dependency relationships, the control unit 5 updates a progress state indicated by the control information 11 so as to re-execute the encoding on another frame or process block which is dependent on the frame or process block where the error has occurred (which, in encoding, refers to the result of the processing executed on the frame or process block where the error has occurred, or receives an influence of the processing executed on the frame or process block where the error has occurred).

As described above, based on the dependency relationships and the progress states of the encoding on the frames or process blocks, the motion vector search unit 2, the mode determination unit 3, and the encoding unit 4 respectively search for a frame or process block on which the processing is executable, and then performs the processing on the found executable frame or executable process block. Consequently, the encoding is re-executed only on the frame or process block where the error has occurred, and the frame or process block dependent on the frame or process block where the error has occurred.

In order to prevent the same error from occurring, setting of the processing may be changed in re-execution.

The various dependency relationships may be incorporated in the motion vector search unit 2, the mode determination unit 3, the encoding unit 4, and the control unit 5. For example, the dependency relationship information may be stored in the storage device 6, and the motion vector search unit 2, the mode determination unit 3, the encoding unit 4, and the control unit 5 may respectively refer to the dependency relationship information to execute the processing.

The motion vector search unit 2, mode determination unit 3, and encoding unit 4 of the encoding device 1 according to the embodiment respectively perform, in parallel, the motion vector search processing, mode determination processing, and entropy encoding processing for one or a plurality of frames included in the moving image data 8.

The error determination unit 7 of the encoding device 1 determines whether the error has occurred in the entropy encoding processing. In this embodiment, the error determination unit 7 corresponds to a detection unit which detects error occurring in the entropy encoding processing.

If the error determination unit 7 determines that the error has occurred, for example, the control unit 5 causes the encoding device 1 to re-executes a part or all of the motion vector search processing, mode determination processing, and entropy encoding processing on the frame where the error has occurred and the subsequent frame, in setting (a mode) in which the same error does not occur.

The control unit 5, for example, causes the mode determination unit 3 and the encoding unit 4 to re-execute the mode determination processing and entropy encoding processing on the process block where the error has occurred and the subsequent process block among the process blocks included in the frame where the error has occurred. Then, the control unit 5 causes the mode determination unit 3 and the encoding unit 4 to re-execute the mode determination processing and entropy encoding processing from the beginning of each frame succeeding to the frame where the error has occurred. In this case, in the frame succeeding to the frame where the error has occurred, the control unit 5 causes the motion vector search unit 2 to re-execute the motion vector search processing on only the process block which refer to a part which has been subjected to re-execution in the frame where the error has occurred.

Furthermore, if the error determination unit 7 determines that the error has occurred, the control unit 5 may causes the motion vector search unit 2, mode determination unit 3, and encoding unit 4 to re-execute the motion vector search processing, mode determination processing and entropy encoding processing from the beginning of the frame where the error has occurred, and then re-execute them from the beginning of each frame succeeding to the frame where the error has occurred.

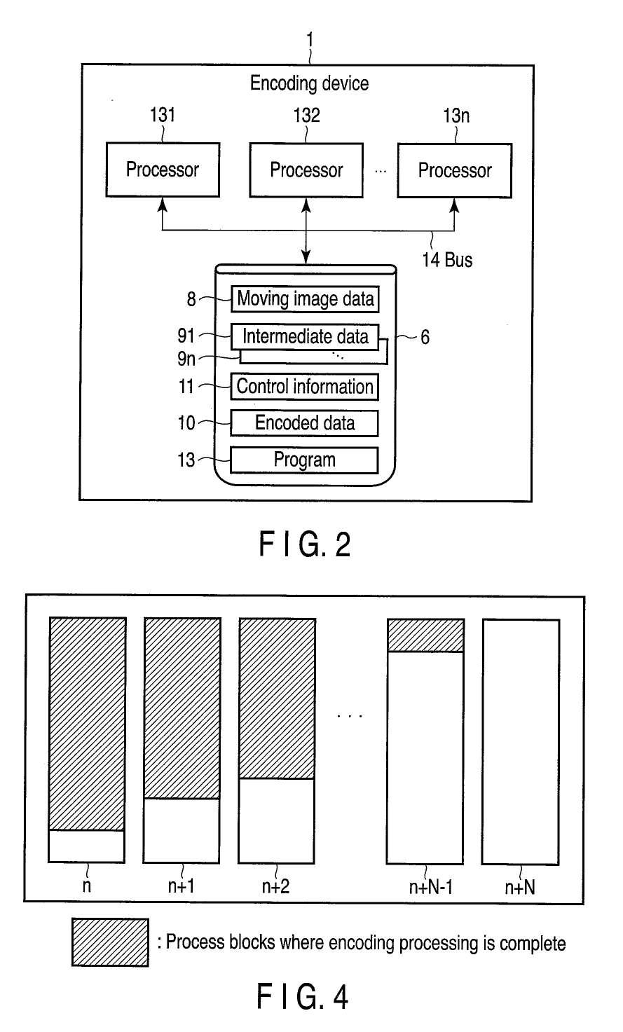

FIG. 2 is a block diagram showing an example of a hardware arrangement of the encoding device 1 according to the embodiment.

The encoding device 1 includes a plurality of processors 131 to 13n, a bus 14, and the storage device 6.

The processors 131 to 13n are operable in parallel. The processors 131 to 13n are connected with each other so as to be able to transfer data via the bus 14. Each of the processors 131 to 13n and the storage device 6 are connected so as to be able to transfer data via the bus 14.

Each of the processors 131 to 13n manages the progress state of encoding in each process block by using the control information 11.

Each of the processors 131 to 13n determines based on the dependency relationship and the control information 11 whether processes included in the motion vector search processing, mode determination processing, and encoding processing are executable on any process block, and then performs the executable processes on a process block which has been determined to be in an executable state.

The motion vector search unit 2, the mode determination unit 3, the encoding unit 4, and the control unit 5 are implemented when, for example, the plurality of processors 131 to 13n execute a program 13 stored in the storage device 6 or the like.

In this embodiment, a second process block dependent on (subordinate to) a first process block is processed after execution in the first process block.

The operation of the encoding device 1 having the above-described arrangement will be described below.

The encoding device 1 according to the embodiment divides the frames included in the moving image data 8 into the process blocks, and parallelly executes processing on the frames or process blocks. This makes it possible to perform encoding at higher speed, as compared with a method of sequentially processing the frames or process blocks by using one processor.

If the error has occurred in any process block or frame in encoding processing, the encoding device 1, for example, re-executes the encoding from the mode determination processing on the process block or frame where the error has occurred. Furthermore, the encoding device 1 re-executes the encoding from the mode determination processing on another process block or frame which refers to the result of the mode determination processing in the process block or frame where the error has occurred.

This makes it possible to perform efficient error control while executing parallel encoding on the process blocks or frames, thus allowing to encode the moving image data at higher speed.

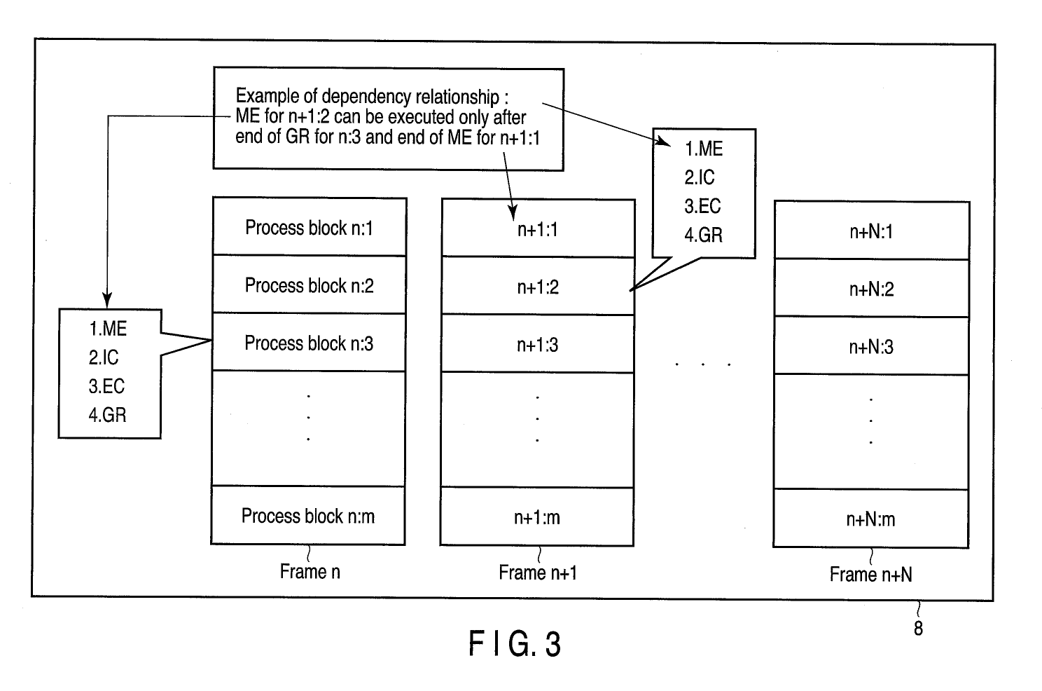

FIG. 3 is a view showing an example of the dependency relationship between the process modes for the process blocks used in the encoding device 1 according to the embodiment.

The encoding device 1 according to the embodiment divides frames n, n+1, . . . , n+N included in the moving image data 8 into process blocks n:1, n:2, . . . , n+N:m each having a fixed length, and manages the frames and process blocks.

The encoding device 1 also divides each of process blocks n:1, n:2, . . . , n+N:m into process modes ME, IC, EC, and GR, and manages the process blocks and process modes. Note that the process modes are process units included in encoding executed in the motion vector search unit 2, mode determination unit 3, and encoding unit 4. In this embodiment, the process mode ME corresponds to motion vector search. The process mode IC corresponds to intra-frame encoding. The processing mode EC corresponds to entropy encoding. The processing mode GR corresponds to reference image generation. The encoding device 1 distributes the various process modes ME, IC, EC, and GR for the process blocks n:1, n:2, . . . , n+N:m among the plurality of processors 131 to 13n, and causes the processors 131 to 13n to execute the process modes.

A given order is defined for the process modes ME, IC, EC, and GR to be performed for a certain process block. In FIG. 3 described above, an execution order of the process modes for a given process block is ME, IC, EC, and GR. The process modes are never executed in an order different from the order defined for the given block.

There are also various dependency relationships between the process modes ME, IC, EC, and GR for the process blocks n:1, n:2, . . . , n+N:m.

Assume that, for example, a first process mode for a first process block is dependent on a second process mode for a second process block. In this case, if the second process mode for the second process block has not been completed, the first process mode for the first process block is not executed.

Assume that the first process mode for the first process block is dependent on the second process mode for the second process block, and a third process mode for a third process block is dependent on the first process mode for the first process block. In this case, the third process mode for the third process block is also dependent on the second process mode for the second process block. The same goes for the case in which the dependency relationship continuously exists. The dependency relationship between process modes exists as long as one of the process modes is influenced by the result of another process mode.

The encoding device 1 according to this embodiment sets, to a re-execution state, the progress state of encoding of the process block where an error has occurred and the process block dependent on the error occurred process block, in consideration of the dependency relationship between the process modes and the dependency relationship between the process modes for process blocks.

This enables the encoding device 1 having the processors 131 to 13n to simultaneously perform the processes, and to re-execute, if the error occurs, only the process associated with the error.

In FIG. 3 described-above, the moving image data 8 includes the frames n, n+1, . . . , n+N.

The frame n includes the process blocks n:1, n:2, . . . , n:m.

The frame n+1 includes the process blocks n+1:1, n+1:2, . . . , n+1:m.

The frame n+N includes the process blocks n+N:1, n+N:2, . . . , n+N:m.

A practical example of the dependency relationship will be explained below. As described above, the dependency relationship may be incorporated in the motion vector search processing, mode determination processing, and entropy encoding processing, or may be managed by the dependency relationship information.

In the first example, it is impossible to execute the process mode ME for the process block n+1:2 unless the process mode GR for the process block n:3 and the process mode ME for the process block n+1:1 are complete.

In the second example, it is impossible to perform the process mode EC for the process block n+1:2 unless the process mode EC for the process block n+1:1 and the process mode IC for the process block n+1:2 are complete.

In the third example, it is impossible to execute the process mode IC for the process block n+1:2 unless the process mode IC for the process block n+1:1 and the process mode ME for the process block n+1:2 are complete.

With respect to the above second example, for the respective last process blocks n:m, n+1:m, . . . , n+N:m of the frames n, n+1, . . . , n+N of frame n, n+1, . . . , n+N, the number of the dependency relationships increases. It is impossible to perform the process mode EC for the process block n+1:m unless the process mode EC for the process block n+1:m−1, the process mode IC for the process block n+1:m, and the process mode EC for the process block n:m are complete.

The processors 131 to 13n read out the control information 11, search for the executable process mode for the process block in the executable state, execute the found process mode for the process block, update the control information 11 after completion of execution, and search for the next executable process mode for the process block in the executable state. The processors 131 to 13n respectively repeat the above control, thereby parallelly encoding the moving image data 8.

The control information 11 contains information indicating to which process mode has progressed in each of the process blocks n:1, n:2, . . . , n+N:m of the frames n, n+1, . . . , n+N.

FIG. 4 is a view showing an example of the progress state of encoding.

As described above, in accordance with the encoding method, the encoding according to this embodiment has a constraint that, for example, the process mode ME for the process block n+1:k of the frame n+1 cannot start unless the process mode GR for the process block n:k−1 of the preceding frame n is complete.

In the encoding according to the embodiment, the encoding for the process blocks advances from an upper process block to a lower process block within the frame, and from the process block of a preceding frame to the process block of a succeeding frame among adjacent frames.

The operation of error control will be explained below.

In some cases, the error may occur during the entropy encoding processing when encoding the moving image data 8.

As an example of the error, for example, a condition that one process block has a predetermined size (e.g., 3200 bits or an original process block size before encoding) or smaller, or the like defined by the H.264 standard is not met, or rate control of the encoded data (output stream) 10 does not satisfy an operating model defined by the H.264 standard (HRD underflow).

If one process block has a size larger than the predetermined size, the following processing is executed.

If the error occurs because one process block has a size larger than the predetermined size, the error determination unit 7 generates the error information 12 based on the identification information of the process block where the error has occurred, the error type information, and the like. The error determination unit 7 then notifies the control unit 5 of the error information 12.

Upon reception of the error information 12 from the error determination unit 7, the control unit 5 instructs the processors 131 to 13n to stop operations of the processors 131 to 13n.

After all the processors 131 to 13n stop, the control unit 5 rewrites the control information 11 in accordance with the received error information 12 and the dependency relationship between the process modes for the process blocks.

More specifically, the control unit 5 rewrites the control information 11 so as to re-execute the encoding from the process mode IC on the process block where the error has occurred.

With respect to at least one frame succeeding to the frame where the error has occurred, the control unit 5 also rewrites the control information 11 so as to re-execute the processing from the process mode ME on the process block referring to the frame where the error has occurred.

After that, the control unit 5 instructs all the processors 131 to 13n to restart the operations. This re-executes the process mode IC for the process block where the error has occurred, re-executes at least one process mode for at least one process block to be executed after the process mode IC for the process block where the error has occurred, and generates encoded data 10 without any error.

Note that if only the process mode IC is re-executed for the frame where the error has occurred, the same settings (option, mode, process type) are selected, and therefore, the same error may occur during the entropy encoding processing. In order to prevent the same error from occurring, when re-executing the process mode IC, settings (for example, an option to cancel the intra-frame encoding in the process mode IC not to perform the intra-frame encoding) in which no error occurs are applied to the process block where the error has occurred, based on the error information 12.

In the encoding including re-execution after error occurrence, the processing may be repeated several times for one process block. In this case, in order to always apply the settings in which no error occurs in the process mode IC, the error determination unit 7 or the control unit 5 of the encoding device 1 stores the error information 12 in the storage device 6 until the entropy encoding processing successfully ends, and if an error occurs, also stores error information 12 on the error occurred in the storage device 6.

The frame where the error has occurred and at least one subsequent frame use the result of the process mode IC (intra-frame encoding) of the preceding frame as the reference frame of the process mode ME (motion vector search). If there exists a second process block referring to a first process block on which the process mode IC (intra-frame encoding) has been re-executed, therefore, the control unit 5 rewrites the control information 11 so as to re-execute the process mode ME (motion vector search) and at least one subsequent process on the second process block.

Since the number of process blocks of the succeeding frame which have been subjected to the processing is smaller as compared with the preceding frame as shown in FIG. 4 described above, re-executing the encoding on the whole succeeding frame has little influence on the processing performance. The control unit 5, therefore, may rewrite the control information 11 so as to re-execute all the process modes on all the process blocks of a frame succeeding, to some extent, to the frame where the error has occurred.

The operation when HRD underflow occurs will be explained next.

If the error determination unit 7 determines that the HRD underflow has occurred, the error determination unit 7 generates the error information 12 including the identification information of the process block where the error has occurred, and the error type information. The error determination unit 7 notifies the control unit 5 of the generated error information 12.

Upon reception of the error information 12, the control unit 5 stops all the processors 131 to 13n. After all the processors 131 to 13n stop, the control unit 5 rewrites the control information 11.

If the picture type of the frame where the error has occurred is a P- or B-picture in the H.264 standard, the control unit 5 updates the control information 11 so as to re-execute the encoding from the beginning of each of all frames up to the next I- or P-picture. In this case, with respect to the frames to be encoded again, the control unit 5 sets, based on the error information 12, the control information 11 so as to cause information for outputting the same frame as before frame to be encoded (so as to set the whole frame to be skipped).

If the picture type of the frame where the error has occurred is an I-picture in the H.264 standard, the control unit 5 updates the control information 11 so as to re-execute the encoding from the beginning of each of all frames up to the next P-picture. In this case, the control unit 5 updates, based on the error information 12, the control information 11 so as to cause the frame where the error has occurred to be encoded as a P-picture, and to set the frame where the error has occurred to be skipped. With respect to the encoding of all B-pictures up to the next P-picture of the frame where the error has occurred, the control unit 5 updates, based on the error information 12, the control information 11 so as to set the frame to be skipped. Furthermore, the control unit 5 updates, based on the error information 12, the control information 11 so as to cause the next P-picture of the frame where the error has occurred to be encoded as an I-picture.

After that, the control unit 5 instructs all the processors 131 to 13n to restart the processing, thereby generating encoded data 10 without any error.

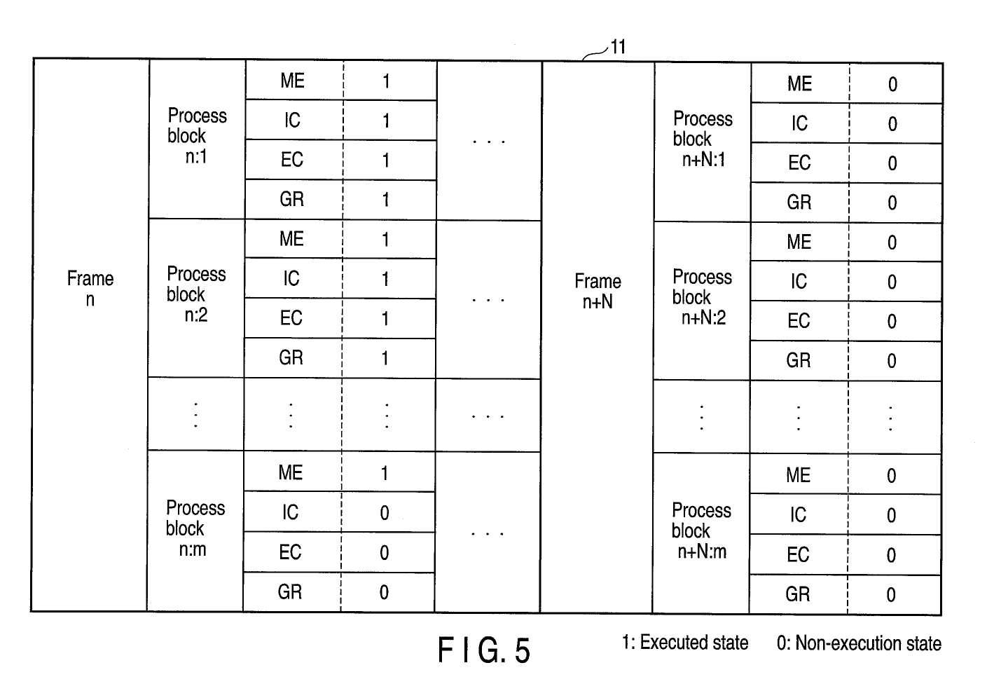

FIG. 5 is a view showing an example of the control information 11 according to the embodiment.

In the control information 11, identification information of at least one frame and identification information of process blocks included in the frame are associated with each other.

In the control information 11, identification information of the process modes are also associated with the identification information of each process block.

Furthermore, in the control information 11, information indicating to which the process mode for the process block has been executed is appended to the identification information of the process mode.

Accessing the control information 11 allows to determine to which process mode processing has been completed for each process block.

In FIG. 5 described above, for example, for the process block n:2 within the frame n, it is possible to determine that the process modes ME to GR have been executed.

Assume that an error has occurred in the process mode (entropy encoding) EC for the process block n:2. In this case, the control unit 5 sets a non-execution state for the process modes IC, EC and GR of the process block n:2 in the control information 11 to re-execute these process modes IC, EC and GR.

The control unit 5 also sets the non-execution state for process modes (other process modes dependent on the process mode in which the error has occurred) in other process blocks influenced by the result of the process modes IC, EC and GR in the process block n:2 where the error has occurred.

Based on the control information 11 and the dependency relationship between the process modes for the process blocks, the motion vector search unit 2, the mode determination unit 3, and the encoding unit 4 search for, from unexecuted process modes for the process blocks, a process mode for which all process modes as reference destinations for process blocks have been executed or an unexecuted process mode independent from any other process modes, and execute a searched process mode for a searched process block.

The control information 11 additionally contains information such as an indication of the type (P-, B-, or I-picture) of a frame to be subjected to re-execution, and a skip setting for a frame to be subjected to re-execution.

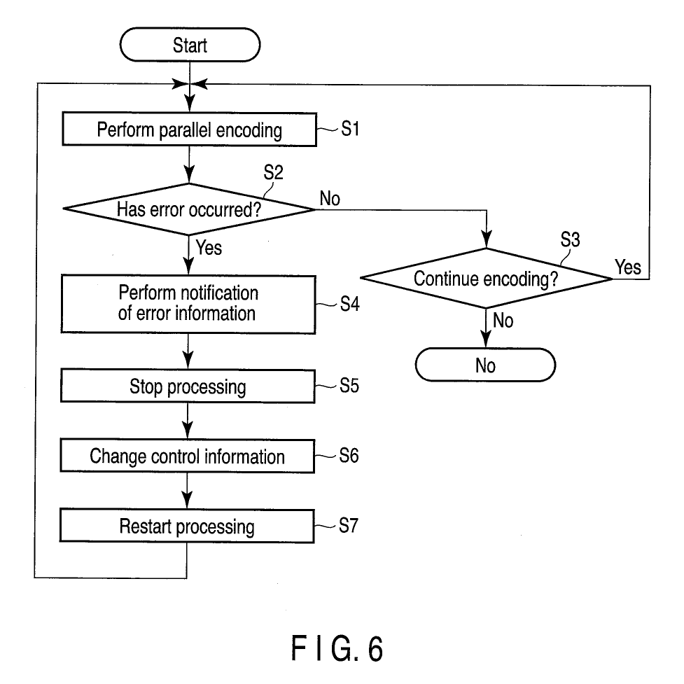

FIG. 6 is a flowchart illustrating an example of processing of the encoding device 1 according to the embodiment.

In step S1, the encoding device 1 executes parallel encoding on process blocks in an executable state.

In step S2, the error determination unit 7 determines whether an error has occurred.

If the error determination unit 7 determines that no error has occurred, the encoding device 1 determines in step S3 whether to continue the encoding. If the encoding device 1 continues the encoding, the process returns to step S1. If the encoding is complete, the process ends.

If the error is determined to have occurred, the error determination unit 7 notifies the control unit 5 of the identification information of a process block where the error has occurred, and the error information 12 containing error type information.

In step S5, the control unit 5 instructs the plurality of processors 131 to 13n to stop the encoding.

In step S6, the control unit 5 updates, based on the error information 12, the state of each process mode for the process block where the error has occurred, and the process block dependent on the error occurred process block. The control unit 5 also changes, based on the error information 12, the control information 11 so as to select the setting in which no error occurs, and to perform the encoding.

In step S7, the control unit 5 instructs the plurality of processors 131 to 13n to restart the encoding, i.e., to execute process modes for the process blocks, which are in an executable state in the control information 11. This returns the process to step S1 to parallelly re-execute the encoding.

In the above-described embodiment, it is possible to execute parallel encoding for image data and implement error processing. If an error occurs, it is possible to efficiently perform the error processing, and to execute encoding while suppressing the influence on the parallel processing.

That is, in this embodiment, if no error occurs during the entropy encoding processing, parallelly executing encoding exerts no influence, thereby increasing the processing speed.

If an error occurs during the entropy encoding processing in this embodiment, an only process mode necessary to be re-executed is executed for a process block for which re-execution is necessary on the condition that no error occurs again. This enables to parallelly execute the encoding, and to re-execute the processing without any error. In this embodiment, it is possible to increase the efficiency of re-execution of the encoding due to occurrence of the error, and decrease the influence of occurrence of the error on the speed of the encoding.

In the embodiment, the error determination unit 7 notifies the control unit 5 of the error information 12. However, the error determination unit 7, for example, may store the error information 12 in the storage device 6, and the control unit 5 read out the error information 12 stored in the storage device 6.

In the embodiment, various components can be freely modified, and can be freely divided or combined. Some (e.g., a function of updating the control information 11 after execution of a process mode) or all functions of the control unit 5 may be distributed and incorporated in the motion vector search unit 2, mode determination unit 3, and encoding unit 4.

In the embodiment, the number of frames included in the moving image data 8 is one or more. In the embodiment, a frame includes at least one process block.

### Second Embodiment

In the second embodiment, a modification of the encoding device 1 according to the above first embodiment will be described.

The encoding device 1 does not know, in advance, a process block where an error will occur and an error occurrence timing. Moving image data in which the number of times of occurrence of an error is large may be a processing target.

The time necessary for re-encoding poses no problem, if the time until encoding is completed is not limited. In encoding such as video encoding for broadcasting, or video encoding in a video conference system, however, the encoding of each frame needs to be completed by a certain time. If the recipient of encoded data has not received encoded data at the time of decoding, it is difficult to smoothly play back moving image data. It is, therefore, necessary to avoid taking a long time to execute re-encoding in encoding requiring real timeness.

In the encoding requiring real timeness, it is desirable to preferentially complete the encoding by a defined time, even if an error occurs because the size of one process block exceeds 3200 bits.

In the above first embodiment, the error determination unit 7 may compare information indicating a time limit for outputting a frame where an error has occurred with a time assumed to be necessary for re-encoding due to this error. Only if it is determined there is enough time until the time limit for outputting the frame where the error has occurred, the error determination unit 7 may notify the control unit 5 of the error information 12.

Error occurrence condition information for determining whether to generate the error information 12, such as a frame output time limit, or a time assumed to be necessary for re-encoding, is set from the viewpoints of experiment, actual measurement, statistics, or theory. The error occurrence condition information may be stored in the storage device 6, or incorporated in the error determination unit 7.

This makes it possible to prioritize real timeness over error recovery.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A parallel encoding device comprising:
a storage unit which stores control information indicating progress states of process modes for encoding with respect to process blocks, the process blocks being obtained by dividing image data;
a parallel processing unit which parallelly executes executable process modes for executable process blocks, based on the control information stored in the storage unit and a predetermined dependency relationship between the process modes for the process blocks;
a detection unit which detects error occurring in processing executed by the parallel processing unit; and
a control unit which updates to a re-executable state, if the detection unit detects the error occurring, the progress state of an error process block and the progress state of a process block dependent on the error process block in the control information stored in the storage unit.

2. A device according to claim 1, wherein
each process block includes a macroblock or sequence macroblocks,
the process modes include motion vector search, intra-frame encoding, entropy encoding, and reference image generation, and
the dependency relationship includes a case in which after a first process mode of the process modes for a first process block of the process blocks is completed, a second process mode of process modes for a second process block of the process blocks is executed.

3. A device according to claim 1, wherein
a motion vector search unit included in the parallel processing unit searches for, based on the control information and a first dependency relationship associated with motion vector search processing, a first process block on which the motion vector search processing is executable, and then executes the motion vector search processing on the first process block,
a mode determination unit included in the parallel processing unit searches for, based on the control information and a second dependency relationship associated with mode determination processing, a second process block on which the mode determination processing is executable, and then executes the mode determination processing on the second process block,
an encoding unit included in the parallel processing unit searches for, based on the control information and a third dependency relationship associated with encoding processing, a third process block on which the encoding processing is executable, and then executes the encoding processing on the third process block, and
a reference image generation unit included in the parallel processing unit searches for, based on the control information and a fourth dependency relationship associated with reference image generation processing, a fourth process block on which the reference image generation processing is executable, and then executes the reference image generation processing on the fourth process block.

4. A device according to claim 1, wherein
the image data is moving image data,
the parallel processing unit parallelly executes motion vector search processing, mode determination processing, entropy encoding processing, and reference image generation processing within one of frames included in the moving image data or among the frames,
the detection unit detects the error occurring in the entropy encoding processing, and
if the detection unit detects the error occurring, the control unit cause the parallel processing unit to re-execute a part or all of the motion vector search processing, the mode determination processing, the entropy encoding processing, and the reference image generation processing for an error frame and a subsequent frame, in setting in which the same error does not occur.

5. A device according to claim 4, wherein the control unit cause the parallel processing unit to re-execute the mode determination processing, the entropy encoding processing, and the reference image generation processing for an error process block and the subsequent process block among process blocks included in the error frame, and re-execute the motion vector search processing, the mode determination processing, the entropy encoding processing, and the reference image generation processing from the beginning of each frame succeeding to the error frame.

6. A device according to claim 4, wherein the control unit cause the parallel processing unit to re-execute the motion vector search processing only for a process block referring to a re-execution part in the error frame, with respect to a frame succeeding to the error frame.

7. A device according to claim 4, wherein if the detection unit detects the error occurring, the control unit cause the parallel processing unit to re-execute the motion vector search processing, the mode determination processing, the entropy encoding processing, and the reference image generation processing from the beginning of the error frame, and re-execute the motion vector search processing, the mode determination processing, the entropy encoding processing, and the reference image generation processing from the beginning of each frame succeeding to the error frame.

8. A device according to claim 4, wherein
the process modes include motion vector search, intra-frame encoding, entropy encoding, and reference image generation, and
the setting in which the same error does not occur are to cancel the intra-frame encoding.

9. A device according to claim 1, wherein the control information indicates a completed process mode of the process modes for each of the process blocks.

10. A device according to claim 1, wherein the encoding complies with an H.264 standard.

11. A device according to claim 10, wherein the detection unit detects, as the error block, a process block including a macroblock having a size not less than a predetermined size or a process block corresponded to HRD underflow occurring.

12. A device according to claim 1, wherein the detection unit compares a set time assumed to be necessary for re-encoding due to the error with a time limit for the error frame for ensuring real time outputting, and only if the set time is short enough with respect to the output time limit, detects the error occurring.

13. A device according to claim 1, wherein the parallel processing unit, the detection unit, and the control unit are implemented by a multiprocessor.

14. A non-transitory computer-readable recording medium recording a computer program which causes at least one processor to execute processing including:
accessing control information which is stored in a storage unit, and indicates progress states of process modes for encoding with respect to process blocks, the process blocks being obtained by dividing image data;
parallelly executing executable process modes for executable process blocks, based on the control information stored in the storage unit and a predetermined dependency relationship between the process modes for the process blocks;
detecting error occurring in the parallel execution; and
updating to a re-execution state, if the error occurring is detected, the progress state of an error process block and the progress state of a process block dependent on the error process block in the control information stored in the storage unit.

15. A non-transitory recording medium according to claim 14, wherein
each process block includes a macroblock or sequence macroblocks,
the process modes include motion vector search, intra-frame encoding, entropy encoding, and reference image generation, and
the dependency relationship includes a case in which after a first process mode of the process modes for a first process block of the process blocks is completed, a second process mode of process modes for a second process block of the process blocks is executed.

16. A non-transitory recording medium according to claim 14, wherein
the image data is moving image data,
the parallelly executing is parallelly executing motion vector search processing, mode determination processing, entropy encoding processing, and reference image generation processing within one of frames included in the moving image data or among the frames,
the detecting is detecting the error occurring in the entropy encoding processing, and
if the error occurring is detected, the updating includes causing the parallelly executing to re-execute a part or all of the motion vector search processing, the mode determination processing, the entropy encoding processing, and the reference image generation processing for an error frame and a subsequent frame, in setting in which the same error does not occur.

17. An encoding image data method being executed by a processor, the method comprising:
accessing control information which is stored in a storage unit, and indicates progress states of process modes for encoding with respect to process blocks, the process blocks being obtained by dividing the image data;
parallelly executing executable process modes for executable process blocks, based on the control information stored in the storage unit and a predetermined dependency relationship between the process modes for the process blocks;
detecting error occurring in the parallel execution; and
updating with a re-execution state, if the error occurring is detected, the progress state of an error process block and the progress state of a process block dependent on the error process block in the control information stored in the storage unit.

18. A method according to claim 17, wherein
each process block includes a macroblock or sequence macroblocks,
the process modes include motion vector search, intra-frame encoding, entropy encoding, and reference image generation, and
the dependency relationship includes a case in which after a first process mode of the process modes for a first process block of the process blocks is completed, a second process mode of process modes for a second process block of the process blocks is executed.

19. A method according to claim 17, wherein
the image data is moving image data,
the parallelly executing is parallelly executing motion vector search processing, mode determination processing, entropy encoding processing, and reference image generation processing within one of frames included in the moving image data or among the frames,
the detecting is detecting the error occurring in the entropy encoding processing, and
if the error occurring is detecting, the updating includes causing the parallelly executing to re-execute a part or all of the motion vector search processing, the mode determination processing, the entropy encoding processing, and the reference image generation processing for an error frame and a subsequent frame, in setting in which the same error does not occur.
